(19) United States
(12) Patent Application Publication
(10) Pub. No.: US 2018/0217722 A1
(43) Pub. Date: Aug. 2, 2018

(54) Method and System for Establishing a Relationship Between a Plurality of User Interface Elements

(71) Applicant: Wipro Limited, Bangalore (IN)

(72) Inventors: Arthi VENKATARAMAN, Bangalore (IN); Suraj VANTIGODI, Dharwad (IN); Raghavendra Rao V, Bangalore (IN)

(21) Appl. No.: 15/459,800

(22) Filed: Mar. 15, 2017

(30) Foreign Application Priority Data
Jan. 31, 2017 (IN) 201741003648

(51) Int. Cl. G06F 3/0482; G06F 3/0484

(52) U.S. Cl. CPC G06F 3/0482; G06F 3/04847

(57) ABSTRACT

Disclosed subject matter relates generally to image processing that includes a method of automatically establishing a relationship between a plurality of User Interface (UI) elements. The present disclosure provides detailed insights related to each UI element in each input image of an application utilizing minimal human intervention. An image processing system identities the UI elements and positions of the UI elements in input images received from one or more sources. Further, a label corresponding to each UI element in each input image is obtained. Finally, a level of each UI element identified in each UI screen is determined to automatically establish the relationship between the UI elements across UI screens. The relationship is established automatically between the plurality of UI elements in real-time, that helps in easy navigation within the UI screen and among the UI screens of the application.

### TECHNICAL FIELD

The present subject matter relates generally to image processing, and more particularly, but not exclusively to a method and a system for establishing a relationship between a plurality of User Interface (UI) elements.

### BACKGROUND

Nowadays, image based User Interface (UI) automation solutions are available in the market. In any image based UI automation solution enormous effort goes in manually understanding details related to each field identified in a UI. Further, when the UI changes, an entire process of getting the details needs to be repeated. Sometimes, UI elements which are identified might be wrong or may not be accurate. This leads to further intervention of a user to manually understand the details of the UI.

Existing techniques include applications that identify a graphical user interface (GUI) element by comparing images received as input with images that are generated from data provided by the applications. The applications then provide the data that describes the GUI element as a result. The applications identify the GUI element, but do not provide any insight on the GUI element that is identified for easy understanding. Some other existing techniques include software related products that are presented for automatic testing of software products such as front-ends of computing devices. Such automatic testing solutions simplify delivery and verification of the software products and services across the computing devices and screens by comparing user interface images using image analysis. For example, a screen buffer or a visual representation of a new version of a software application can be compared with those representations generated using one or more previously released software versions of the software application. Such methods improvises scope and facilitates automation of workflows that previously required a lot of human interaction. However, the automatic testing solutions work by comparing two user interface images of a same screen bet having different versions. Therefore, such solutions might not be able to perform the image analysis when a new image is provided without any pre-stored data related to the new image.

### SUMMARY

One or more shortcomings of the prior art may be overcome said additional advantages may be provided through the present disclosure. Additional features and advantages may be realized through the techniques of the present disclosure. Other embodiments and aspects of the disclosure are described in detail herein and are considered a part of the claimed disclosure.

Disclosed herein is a method for establishing a relationship between plurality of User Interface (UI) elements. The method includes receiving by an image processing system, one or more input images related to one or more UI screens of an application from one or more sources. Upon receiving the one or more input images, the image processing system identifies the plurality of UI elements and respective positions of the plurality of UI elements in each of the one or more input images. Further, the image processing system obtains a label corresponding to each of the plurality of UI elements in each of the one or more input images. Finally, the image processing system determines a level of each of the plurality of UI elements identified in each of the one or more UI screens to automatically establish the relationship between the plurality of UI elements across the one or more UI screens.

Further, the present disclosure includes an image processing system for establishing a relationship between plurality of User Interface (UI) elements. The image processing system includes a processor and a memory communicatively coupled to the processor, wherein the memory stores the processor-executable instructions, which, on execution, causes the processor to receive one or more input images related to one or more UI screens of an application from one or more sources. Upon receiving the one or more input images, the processor identifies plurality of UI elements and respective positions of the plurality of UI elements in each of the one or more input images. Further, the processor obtains a label corresponding to each of the plurality of UI elements in each of the one or more input images. Finally, the processor determines a level of each of the plurality of UI elements identified in each of the one or more UI screens to automatically establish the relationship between the plurality of UI elements across the one or more UI screens.

Further, the present disclosure comprises a non-transitory computer readable medium including instructions stored thereon that when processed by at least one processor causes an image processing system to perform operations comprising receiving one or more input images related to one or more UI screens of an application from one or more sources. Further, the instructions cause the processor to identify the plurality of UI elements and respective positions of the plurality of UI elements in each of the one or more input images. Furthermore, the instructions cause the processor to obtain a label corresponding to each of the plurality of UI elements in each of the one or more input images. Finally, the instructions cause the processor to determine a level of each of the plurality of UI elements identified in each of the one or more UI screens to automatically establish the relationship between the plurality of UI elements across the one or more UI screens.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DIAGRAMS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

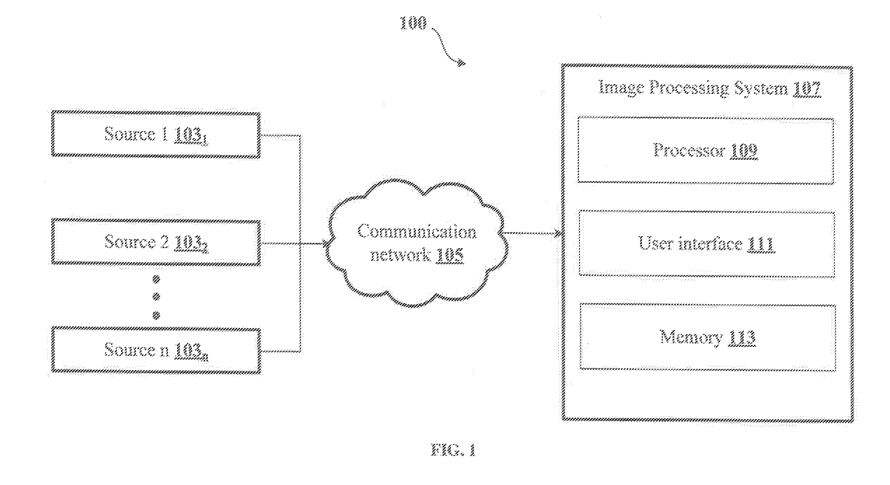

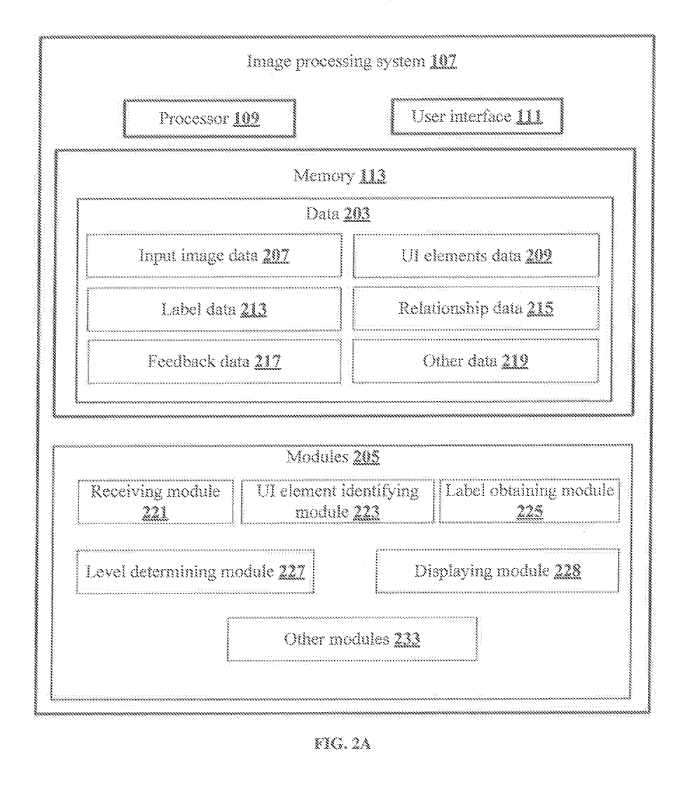

FIG. 1 shows an exemplary architecture for automatically establishing a relationship between a plurality of User Interface (UI) elements in accordance with some embodiments of the present disclosure;

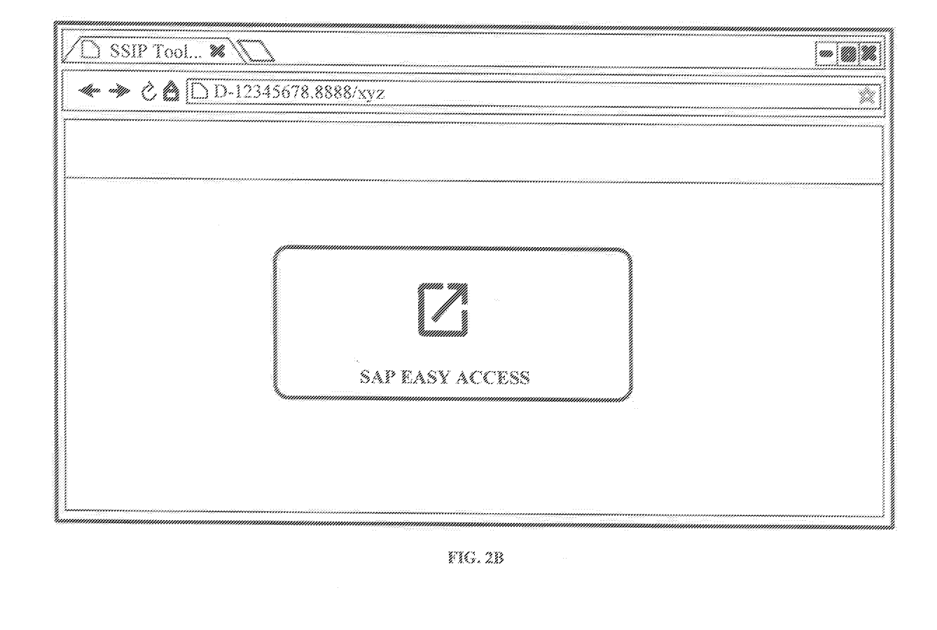

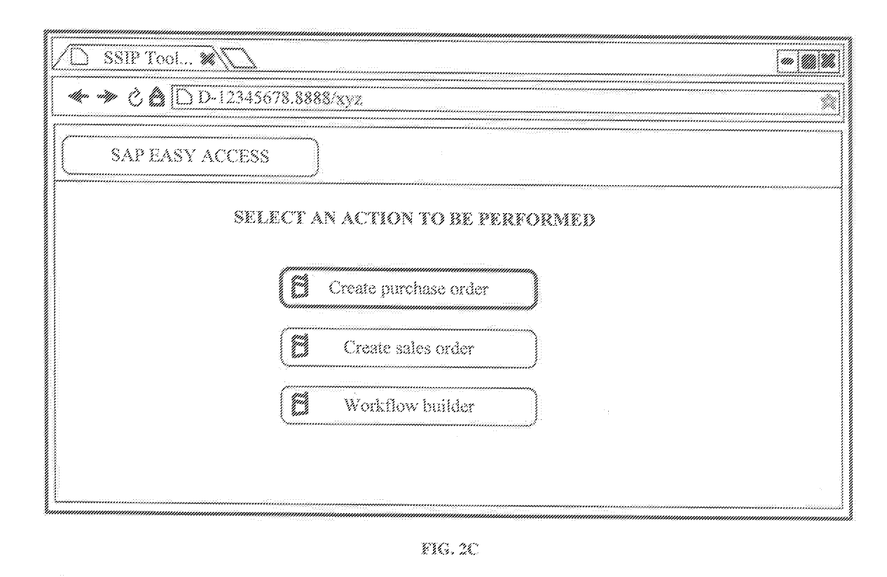

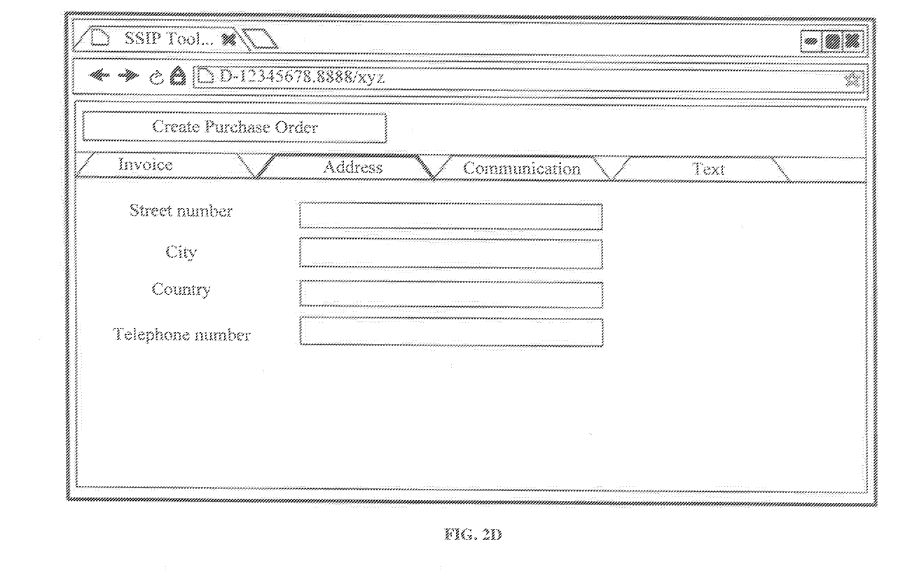

FIG. 2A shows a detailed block diagram of an image processing system for establishing a relationship between a plurality of User Interface (UI) elements in accordance with some embodiments of the present disclosure;

FIG. 2B, FIG. 2C and FIG. 2D shows exemplary input images of exemplary UI screens of an application with some embodiments of the present disclosure;

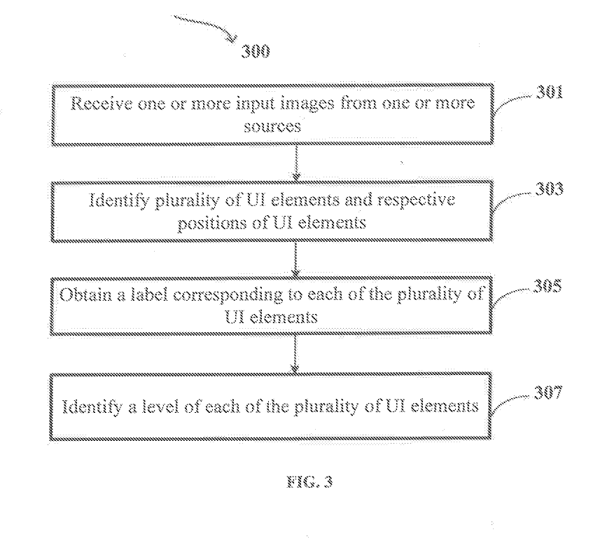

FIG. 3 shows a flowchart illustrating a method for establishing a relationship between a plurality of User Interface (UI) elements in accordance with some embodiments of the present disclosure; and

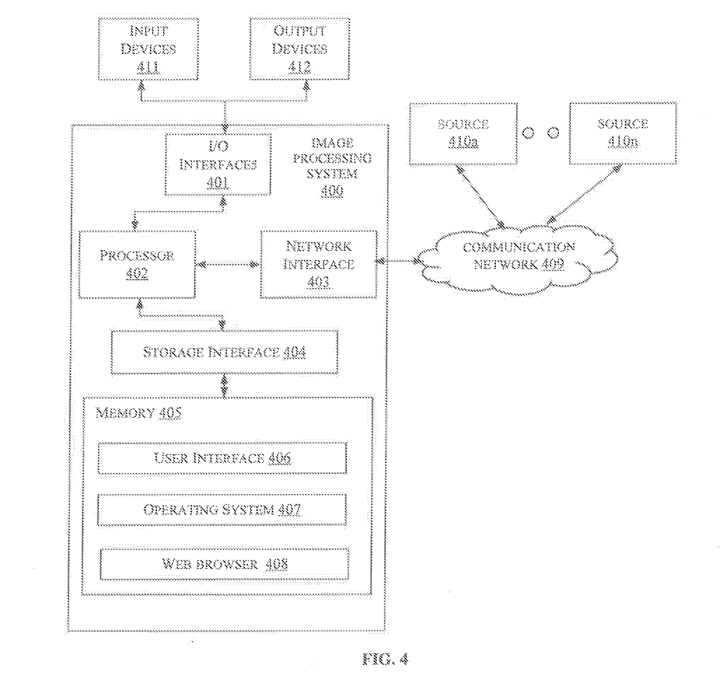

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the scope of the disclosure.

The terms “comprises”, “comprising”, “includes” or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Disclosed herein is a method for establishing a relationship between a plurality of User Interface (UI) elements. The image processing system receives one or more input images related to one or more UI screens of an application from one or more sources. As an example, the one or more sources may include, but not limited to, an image repository and an image capturing device such as a camera, a mobile, a tablet and the like. Upon receiving the one or more input images, the image processing system may identify the plurality of UI elements and respective positions of the plurality of UI elements in each of the one or more input images. Further, the image processing system may obtain a label corresponding to each of the plurality of UI elements in each of the one or more input images. The image processing system obtains the label by extracting text from sub-images that are created by cropping regions of each of the plurality of UI elements. Further, the image processing system determines a level of each of the plurality of UI elements identified in each of the one or more UI screens to automatically establish the relationship between the plurality of UI elements across the one or more UI screens. The present disclosure provides detailed insights related to each UI element in each input image. Further, a parent-child relationship is automatically established between the plurality of UI elements in real-time, which helps in easy navigation within the UI screen and among the UI screens of the application.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1 shows an exemplary architecture for establishing a relationship between a plurality of User Interface (UI) elements in accordance with some embodiments of the present disclosure.

The architecture 100 includes one or more sources, source 1 103₁ to source n 103ₙ (collectively referred to as one or more sources 103), a communication network 105 and an image processing system 107. As an example, the one or more sources 103 may include, but are not limited to, an image repository and an image capturing device such as a camera, a mobile, a tablet and the like. The image processing system 107 interacts with the one or more sources 103 via the communication network 105. The communication network 105 may be at least one of a wired communication network and a wireless communication network.

The image processing system 107 includes a processor 109, a user interface 111 and a memory 113. The user interface 111 receives one or more input images related to one or more UI screens of an application from the one or more sources 103. As an example, consider “Microsoft Outlook” is the application, the one or more input images related to one or more UI screens of “Microsoft Outlook” is received by the user interface 111. The processor 109 identifies a plurality of UI elements present in each of the one or more input images. As an example, the plurality of UI elements may include, but not limited to, buttons, tabs, tables and text boxes. Further, the processor 109 identifies positions of the plurality of UI elements that are identified. In an embodiment, the positions of the plurality of UI elements may be identified by storing co-ordinates of the identified UI elements. Furthermore, the processor 109 extracts a label corresponding to each of the plurality of UI elements identified in each of the one or more input images. In an embodiment, the processor 109 obtains sub-images by cropping regions of each of the plurality of UI elements. Upon obtaining the sub-images, text is extracted from each sub-image, thereby obtaining the label corresponding to each of the plurality of UI elements. In an embodiment, the processor 109 may extract the text from each of the one or more sub-images using a deep learning model. Upon extracting the label corresponding to each of the plurality of UI elements, the processor 109 determines a level of each of the plurality of UI elements identified in each of the one or more UI screens. The level determined for each of the plurality of UI elements automatically establishes a relationship between the plurality of UI elements across the one or more UI screens. The relationship established between the plurality of UI elements across the one or more UI screens helps in easy navigation from one UI screen to another UI screen.

FIG. 2A shows a detailed block diagram of the image processing system 107 for establishing the relationship between the plurality of User Interface (UI) elements in accordance with some embodiments of the present disclosure.

In some implementations, the image processing system 107 includes data 203. As an example, the data 203 is stored in the memory 113 configured in the image processing system 107 as shown in the FIG. 2A. Its one embodiment, the data 203 includes an input image data 207, a UI elements data 209, a label data 213, a relationship data 215, a feedback data 217 and other data 219. In the illustrated FIG. 2A, modules 205 are described herein in detail.

In some embodiments, the data 203 may be stored in the memory 113 in form of various data structures. Additionally, the data 203 can be organized using data models, such as relational or hierarchical data models. The other data 219 may store data, including temporary data and temporary files, generated by the modules 205 for performing the various functions of the image processing system 107.

In some embodiments, the input image data 207 may include one or more input images received by the image processing system 107 from the one or more sources 103. In some embodiments, the one or more inputs images are related to one or more UI screens of an application.

In some embodiments, the UI elements data 209 may include the plurality of UI elements identified in each of the one or more input images. Further, the UI elements data 209 also includes respective positions of the plurality of UI elements. In some embodiments, the positions of the plurality of UI elements may be identified by storing co-ordinates of the plurality of UI elements. Further, the UI elements data 209 may include sorted representation of the plurality of UI elements. In some embodiment, a sorting pattern may include, but not limited to, a left-to-right pattern or a top-to-bottom pattern. Each of the plurality of UI elements may include a value that indicates the respective positions in the one or more input images based on the sorting pattern.

In some embodiments, the label data 215 may include a label corresponding to each of the plurality of UI elements in each of the one or more input images. Further, the label data 213 may include sub-images of each of the one or more input images received by the image processing system 107. As an example, the sub-images may include, but not limited to, header regions of the plurality of UI elements. In some embodiment, the label corresponding to each of the plurality of UI elements is extracted based on the sub-images of each of the plurality of UI elements.

In some embodiments, the relationship data 215 may include a level of each of the plurality of the UI elements identified in each of the one or more UI screens. The level of each of the plurality of the UI elements is a number that helps in automatically establishing a relationship between the plurality of UI elements. As an example, consider a UI element “Tab” labelled as “Address” and other UI elements that appear upon clicking the “Address” tab are UI elements “Textbox” labelled as “Street”, “Pin code” and “City”. Therefore, “Address” tab is considered as a parent node and the textboxes labelled as “Street”, “Pin code” and “City” are considered as child nodes of the parent node “Address” tab. Therefore, level of “Address” tab may be 1 and level of each textbox labelled as “Street”, “Pin code” and “City” may be 2.

In some embodiments, the feedback data 217 may include one or more user inputs received from a user associated with the image processing system 107. In some embodiments, the one or more user inputs may be related to faults in UI element identification, semantic and grammatical errors, altering information related to the UI elements, and the like.

In some embodiments, the data stored in the memory 113 is processed by the modules 205 of the image processing system 107. The modules 205 may be stored within the memory 113. In an example, the modules 205 communicatively coupled to a processor 109 configured in the image processing system 107, may also be present outside the memory 113 as shown in FIG. 2A and implemented as hardware. As used herein, the term modules refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 205 may include, for example, a receiving module 221, a UI element identifying module 223, a label obtaining module 225, a level determining module 227, a displaying module 228 and other modules 233. The other modules 233 may be used to perform various miscellaneous functionalities of the image processing system 107. It will be appreciated that such aforementioned modules 205 may be represented as a single module or a combination of different modules.

In some embodiments, the receiving module 221 receives the one or more input images related to the one or more UI screens of the application from the one or more sources 103.

In some embodiments, the UI element identifying module 223 identifies the plurality of UI elements from the one or more input images. As an example, the plurality of UI elements may include, but not limited to, buttons, tabs, tables and text boxes. The UI element identifying module 223 may identify the plurality of UI elements using one or more methods as illustrated below.

### Method—1

In this method, the UI element identifying module 223 may identify the plurality of UI elements based on shape of the plurality of UI elements. Majority of the plurality of UI elements are generally rectangular. Therefore, the UI element identifying module 223 may identify rectangular patterns present in each of the one or more input images as the plurality of UI elements. In some embodiments, the processor 109 may be configured to identify other patterns in each of the one or more input images such as a square pattern, a circular pattern, an oval pattern and the like. The one or more input images are initially converted into gray scale and farther a filter such as a Laplacian filter may be applied on each of the one or more input images converted into the gray scale to identify the plurality of UI elements. Further, the UI element identifying module 223 also identifies respective positions of the UI elements by recording co-ordinates of each of the plurality of UI elements in each of the one or more input images.

### Method—2

In this method, the UI element identifying module 223 may execute a predefined algorithm such as a convolutional neural network algorithm. In some embodiments, the predefined algorithm is trained with standard images of different UI elements. Therefore, the UI element identifying module 223 automatically identifies the plurality of UI elements using the predefined algorithm. Further, the UI element identifying module 223 also identifies respective positions of the UI elements by recording the co-ordinates of each of the plurality of UI elements in each of the one or more input images.

### Method—3

In this method, the UI element identifying module 223 may recognize one or more user inputs received by manual intervention. A user associated with the image processing system 107 performs one or more actions through input devices such as a mouse, a keyboard etc. The user selects the UI element on a user interface 111 associated with the image processing system 107 and then performs “click” and “drag” action on the UI element. The UI element identifying module 223 records the start and end co-ordinates of the “click” and “drag” action. The start and end co-ordinates indicate position of the UI element. The user may provide one or more user inputs for rectifying faults in the UI element identification, for rectifying semantic and grammatical errors and for altering information related to the UI elements.

In some embodiments, the label obtaining module 225 may obtain the label corresponding to each of the plurality of UI elements identified by the UI element identifying module 223. The label obtaining module 225 initially obtains sub-images of each of the one or more input images by cropping regions of each of the plurality of UI elements. Upon obtaining the sub-images, the label obtaining module 225 extracts text from each sub-image to obtain the label corresponding to each of the plurality of UI elements. In an embodiment, the label obtaining module 225 may extract the text from each of the one or more sub-images using a deep learning model. As an example, consider a UI element “Tab” labelled as “Address”. The label obtaining module 225 obtains the sub image of the UI element by cropping the region comprising the label of the UI element. Upon obtaining the sub-image, the label obtaining module 225 provides the sub-image to the deep learning model to extract text from the sub-image and obtain the label corresponding to the UI element as “Address”.

In some embodiments, the level determining module 227 may determine level of each of the plurality of UI elements. The level determining module 227 initially sorts each of the plurality of UI elements identified in each of the one or more UI screens based on the respective positions. In some embodiments, the sorting pattern may include, but not limited to, a Left-to-right pattern or a Top-to-bottom pattern. Sorting brings out relativity among the respective positions of each of the plurality of UI elements. The level determining module 227 assigns a value to each of the plurality of UI elements that indicates the respective positions in each of the one or more input images based on the sorting. As an example, consider a command that reads “GOTO UI element 7”. In the above example, 7 is the value assigned by the level determining module 227 to the UI element upon sorting. The value 7 indicates the respective position of the UI element. This command can be easily performed since each of the plurality of UI elements are assigned with the value indicating the respective position in each of the one or more input images. Upon sorting, the level determining module 227 identifies a common label in the one or more UI screens. In some embodiments, the plurality of UI elements in each of the one or more input images are considered as child nodes of the window name of the corresponding input image. Further, the label obtained for a particular UI element in one of the one or more input images may be the same for that UI element in each of the one or more input images. Furthermore, the level determining module 227 associates the plurality of UI elements present in the one or more UI screens based on the common label. Upon associating the plurality of UI elements, the level determining module 227 assigns a number to each of the plurality of UI elements based on the association. In some embodiments, the number assigned to each of the plurality of UI elements indicates the level of each of the plurality of UI elements, thereby establishing the relationship between the plurality of UI elements automatically. In some embodiments, the UI element “Tab” is considered as one level higher than the rest of the plurality of UI elements.

In some embodiments, the displaying module 228 displays results that may include the plurality of UI elements, the respective positions of the plurality of UI elements, the label corresponding to each of the plurality of UI elements and the level of each of the plurality of UI elements on the user interface 111 associated with the image processing system 107. In some embodiments, the displaying module 228 displays the results at any given point of time on demand of the user. Upon displaying the results, if the user believes that the result needs rectification, the user may provide the one or more user inputs and the result may be updated dynamically. In some embodiments, updating the result may include overriding the result with the one or more user inputs to obtain a new result. Further, the processor 109 dynamically gets trained based on the one or more user inputs.

Henceforth, the process of automatically establishing a relationship between the plurality of UI elements is explained with the help of one or more examples for better understanding of the present disclosure. However, the one or more examples should not be considered as limitation of the present disclosure.

Consider a scenario related to an application as shown in FIG. 2B, FIG. 2C and FIG. 2D. Also, consider that FIG. 2B is an input image 1 of UI screen 1, FIG. 2C is an input image 2 of UI screen 2 and FIG. 2D is an input image 3 of UI screen 3. The input image 1 of the UI screen 1, the input image 2 of the UI screen 2 and the input image 3 of the UI screen 3 are provided as input to the image processing system 107. Upon receiving the input images, the processor 109 identifies UI elements in each of the input images based on at least one of the method 1, method 2 or method 3 as described in the above modules. The processor 109 identifies a UI element “button” labelled as “SAP EASY ACCESS” in the input image 1 of UI screen 1. Further, the processor 109 identifies 3 UI elements “buttons” labelled as “Create purchase order”, “Create sales order” and “Workflow builder” in the input image 2 of UI screen 2. Furthermore, the processor 109 identifies UI element “Tab” labelled as “Address” in the input image 3 of UI screen 3. Further, the processor 109 identifies lit elements “Textbox” labelled as “Street number”, “City”, “Country” and “Telephone number” that are appear below the UI element “Tab” labelled as “Address”. Upon identifying the plurality of UI elements in each of the input images, the processor 109 obtains sub-images of the input image 1, input image 2 and input image 3 by cropping regions of the input image 1, input image 2 and input image 3. The processor 109 extracts text from each sub-image to obtain the lane; corresponding to each of the plurality of UI elements identified in each of the input images. Upon extracting the label corresponding to each of the plurality of UI elements, the processor 109 displays the plurality of UI elements and information related to the plurality of UI elements as shown in the below Table 1.

TABLE 1

| UI | Extracted | | | Modified |
|---|---|---|---|---|
| element | Text | Label | Level | text |
| Button | SAP EASY | SAP EASY | 0 | SAP EASY |
| | ACCESS | ACCESS | | ACCESS |
| Button | Create purchase | Create purchase | 0 | Create purchase |
| | order | order | | order |
| Button | Create Sales | Create Sales | 0 | Create Sales |
| | order | order | | order |
| Button | Wo rkflow | Wo rkflow | 0 | Wo rkflow |
| | Buiider | Buiider | | Buiider |
| Tab | Address | Address | 0 | Address |
| Textbox | Street Number | Street Number | 0 | Street Number |
| Textbox | City | City | 0 | City |
| Textbox | Country | Country | 0 | Country |
| Textbox | Telephone | Telephone | 0 | Telephone |
| | number | number | | number |

Upon displaying the Table 1, the user may provide one or more inputs if required. As an example. In the above Table 1, the label obtained for the UI element “Button” labelled as “Workflow builder” is not correct. Therefore, the user provides one or more user inputs to correct the extracted text and thereby updates the one or more user inputs dynamically. In the above Table 1, current data in the column “modified text” may be same as the obtained label for the corresponding UI element by default. If the user provides the one or more user inputs to perform a few corrections, the one or more user inputs overrides the current data present in the column “modified text” and the label obtained is corrected based on the one or more user inputs. The updated data is as shown in the below Table 2.

TABLE 2

| UI | Extracted | | | Modified |
|---|---|---|---|---|
| element | Test | Label | Level | text |
| Button | SAP EASY | SAP EASY | 0 | SAP EASY |
| | ACCESS | ACCESS | | ACCESS |
| Button | Create purchase | Create purchase | 0 | Create purchase |
| | order | order | | order |
| Button | Create Sales | Create Sales | 0 | Create Sales |
| | order | order | | order |
| Button | Workflow | Workflow | 0 | Workflow |
| | Builder | Builder | | Builder |
| Tab | Address | Address | 0 | Address |
| Textbox | Street Number | Street Number | 0 | Street Number |
| Textbox | City | City | 0 | City |
| Textbox | Country | Country | 0 | Country |
| Textbox | Telephone | Telephone | 0 | Telephone |
| | number | number | | number |

Further, the processor 109 dynamically gets trained based on the one or more user inputs. Thereafter, the processor 109 may extract the text correctly as “workflow builder” and not as “workflow Builder”. In an embodiment, the user may view the plurality of UI elements and related information as per requirement and provide one or more user inputs. Further, the processor 109 may determine a level of each of the plurality of UI elements identified in each of the input images. The processor 109 identifies the UI element “Button” labelled as “SAP EASY ACCESS” as a common label among the input image 1 of the UI screen 1, the input image 2 of the UI screen 2 and the input image 3 of the UI screen 3. Further, the processor 109 may identify the UI element “Button” labelled as “Create purchase order” as a common label among the input image 2 of the UI screen 2 and the input image 3 of the UI screen 3. Therefore, the processor 109 associates the UI element “Button” labelled as “SAP EASY ACCESS” and the UI element “Button” labelled as “Create purchase order” by assigning a number to each of the identified UI elements. The UI element “Button” labelled as “SAP EASY ACCESS” may be assigned with number “1” and the UI element “Button” labelled as “Create purchase order” may be numbered as “2”. The assigned numbers indicate the level of the UI elements. Therefore, based on the level, the UI element “Button” labelled as “SAP EASY ACCESS” is considered as parent node of the UI element “Button” labelled as “Create purchase order”. Similarly, the level is determined for the other UI elements “Tab” and “Textbox” identified in input image 2 of UI screen 2 and the input image 3 of the UI screen 3. The parent-child relationship between the plurality of UI elements based on the determined level is as shown in the below Table 3.

TABLE 3

| element | Text | | | text | level | name |
|---|---|---|---|---|---|---|
| Button | SAP EASY | SAP EASY | 1 | SAP EASY | 0 | SAP EASY |
| | ACCESS | ACCESS | | ACCESS | | ACCESS |
| Button | Create | Create | 2 | Create | 1 | SAP EASY |
| | purchase | purchase | | purchase | | ACCESS |
| | order | order | | Order | | |
| Tab | Address | Address | 3 | Address | 2 | Create |
| | | | | | | purchase |
| | | | | | | order |
| Textbox | Street | Street | 4 | Street | 3 | Address |
| | Number | Number | | Number | | |
| Textbox | City | City | 4 | City | 3 | Address |
| Textbox | Country | Country | 4 | Country | 3 | Address |
| Textbox | Telephone | Telephone | 4 | Telephone | 3 | Address |
| | number | number | | number | | |

Therefore, the processor 109 establishes a relationship between the plurality of UI elements within the UI screen as well as among the UI screens.

FIG. 3 shows a flowchart illustrating a method of establishing a relationship between a plurality of User Interface (UI) elements in accordance with some embodiments of the present disclosure.

As illustrated in FIG. 3, the method 300 includes one or more blocks illustrating a method for establishing a relationship between plurality of User Interface (UI) elements. The method 300 may be described in the general context of computer executable instructions. Generally, computer executable instructions can include routines, programs, objects, components, data structures, procedures, modules, and functions, which perform functions or implement abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method 300 includes receiving, by a processor 109 of the Image processing system 107, one or more input images related to one or more UI screens from one or more sources 103. As an example, the one or more sources 103 may include, but not limited to, an image repository and an image capturing device such as a camera, a mobile, a tablet etc.

At block 303, the method 300 includes identifying, by the processor plurality of User Interface (UI) elements and respective positions of each of the plurality of UI elements. As an example, the plurality of UI elements may include, but not limited to, buttons, tabs, tables and text boxes. In some embodiments, the processor 109 identifies the positions of the plurality of UI elements by storing co-ordinates of the plurality of UI elements. In some embodiments, the processor 109 identifies the plurality of UI elements and the respective positions of the UI elements by using one or more methods described under the UI element identifying module 223 in the FIG. 2A.

At block 305, the method 300 includes, obtaining, by the processor 109, a label corresponding to each of the plurality of UI elements. In some embodiments, the processor 109 initially obtains sub-images of each of the one or more input images by cropping regions of each of the plurality of UI elements. As an example, the sub-images may include, but not limited to, header regions of the plurality of UI elements. Upon obtaining the sub-images, the processor 109 extracts text from each sub-image to obtain the label corresponding to each of the plurality of UI elements.

At block 307, the method 300 includes, identifying by the processor 109, a level of each of the plurality of UI elements. In some embodiments, the processor 109 initially sorts each of the plurality of UI elements identified in each of the one or more UI screens based on the respective positions. Sorting brings out relativity among the respective positions of each of the plurality of UI elements. The processor 109 assigns a value to each of the plurality of UI elements that indicates the respective positions in each of the one or more input images based on the sorting. Upon sorting, the processor 109 identifies a common label in the one or more UI screens. Further, the processor 109 associates the plurality of UI elements present in the one or more UI screens based on the common label. Upon associating the plurality of UI elements, the processor 109 assigns a number to each of the plurality of UI elements based on the association. In some embodiments, the number assigned to each of the plurality of UI elements indicates the level of each of the plurality of UI elements, thereby establishing the relationship between the plurality of UI elements automatically.

FIG. 4 is a block diagram of an exemplary computer system for implementing embodiments consistent with the present disclosure.

In an embodiment, the image processing system 400 is used for establishing a relationship between plurality of User Interface (UI) elements. The image processing system 400 may include a central processing unit (“CPU” or “processor”) 402. The processor 402 may include at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 491 may employ communication protocols/methods such as, without limitation, audio, analog, digital, stereo, IEEE-394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the image processing system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the image processing system 400 may communicate with one or more sources 410 (a, . . . , n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example. Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more sources 410 (a, . . . , n) may include, but not limited to, a an image repository and an image cantering device such as a camera, a mobile, a tablet etc. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, the image processing system 400 may store user/application data, such as the data, variables, records, etc. as described in this invention. Such databases may be implemented as fault-tolerant, relational, scalable, secure databases such as Oracle or Sybase.

The operating system 407 may facilitate resource management and operation of the image processing system 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the image processing system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the image processing system 400 may implement a web browser 408 stored program components. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the image processing system 400 may implement a mall server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming interface (MAPI), Microsoft Exchange, Post Office Protocol (POP), Simple Mail Transfer Protocol (SMTP), or the like. In some embodiments, the image processing system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

### Advantages of the Embodiment of the Present Disclosure are Illustrated Herein.

In an embodiment, the present disclosure provides a method and a system for establishing a relationship between a plurality of User Interface (UI) elements.

The present disclosure provides detailed insights related to each UI element in each input image related to a UI screen of an application.

The present disclosure establishes a parent-child relationship between the plurality of UI elements that helps in easy navigation within the UI screen and among the UI screens of the application.

The present disclosure requires minimal human intervention as most of the process is automated.

The present disclosure provides a feature, where the plurality of UI elements are identified for any new application irrespective of historical data present in the image processing system.

A description of an embodiment with several components in communication with each other does not imply that all such components are required. On the contrary a variety of optional components are described to illustrate the wide variety of possible embodiments of the invention.

When a single device or article is described herein, it will be apparent that more than one device/article (whether or not they cooperate) may be used in plane of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for establishing a relationship between plurality of User Interface (UI) elements. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fell within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

### REFERENCE NUMERALS

| Reference Number | Description |
|---|---|
| 100 | Architecture |
| 103 | One or more sources |
| 105 | Communication network |
| 107 | Image processing system |
| 109 | Processor |
| 111 | User interface |
| 113 | Memory |
| 203 | Data |
| 205 | Modules |
| 207 | Input image data |
| 209 | User Interface (UI) elements data |
| 213 | Label data |
| 215 | Relationship data |
| 217 | Feedback data |
| 219 | Other date |
| 221 | Receiving module |
| 223 | UI element identifying module |
| 225 | Label obtaining module |
| 227 | Level determining module |
| 228 | Displaying module |
| 233 | Other modules |

What is claimed is:

1. A method of establishing a relationship between a plurality of User Interface (UI) elements, the method comprising:
receiving, by an image processing system (107), one or more input images related to one or more UI screens of an application from one or more sources (103);
identifying, by the image processing system (107), the plurality of UI elements and respective positions of the plurality of UI elements in each of the one or more input images;
obtaining, by the image processing system (107), a label corresponding to each of the plurality of UI elements in each of the one or more input images; and
determining, by the image processing system (107), a level of each of the plurality of UI elements identified in each of the one or more UI screens to automatically establish the relationship between the plurality of UI elements across the one or more UI screens.

2. The method as claimed in claim 1 further comprises:
displaying, by the image processing system (107), the plurality of UI elements, the respective positions of the plurality of UI elements, the label corresponding to each of the plurality of UI elements and the level of each of the plurality of UI elements on a user interface (111) associated with the image processing system (107); and
updating, by the image processing system (107), dynamically, the plurality of UI elements, the respective positions of the plurality of UI elements, the label corresponding to each of the plurality of UI elements and the level of each of the plurality of UI elements on receiving one or more inputs from a user.

3. The method as claimed in claim 1, wherein obtaining the label comprises:
obtaining, by the image processing system (107), sub-images of each of the one or more input images by cropping regions of each of the plurality of UI elements; and
extracting, by the image processing system (107), text from each sub-image.

4. The method as claimed in claim 1, wherein the plurality of UI elements is at least one of buttons, tabs, tables, and text boxes.

5. The method as claimed in claim 1, wherein determining the level of each of the plurality of UI elements across each of the one or more UI screens comprises:
sorting, by the image processing system (107), each of the plurality of UI demerits identified in each of the one or more UI screens based on the respective positions;
identifying, by the image processing system (107), a common label in the one or more UI screens;
associating, by the image processing system (107), the plurality of UI elements in the one or more UI screens based on the common label; and
assigning, by the image processing system (107), a number to each of the plurality of UI elements based on the association, wherein the number indicates the level of each of the plurality of UI elements.

6. An image processing system (107) for establishing a relationship between a plurality of User Interface (UI) elements, the image processing system (107) comprising:
a processor (109): and
a memory (113) communicatively coupled to the processor (109), wherein the memory (113) stores the processor-executable instructions, which, on execution, causes the processor (109) to:
receive one or more input images related to one or more UI screens of an application from one or more sources (103);
identify plurality of UI elements and respective positions of the plurality of UI elements in each of the one or more input images;
obtain a label corresponding to each of the plurality of UI elements in each of the one or more input images; and
determine a level of each of the plurality of UI elements identified in each of the one or more UI screens to automatically establish the relationship between the plurality of UI elements across the one or more UI screens.

7. The image processing system (107) as claimed in claim 6, wherein the processor (109) is further configured to:
display the plurality of UI elements, the respective positions of the plurality of UI elements, the label corresponding to each of the plurality of UI elements and the level of each of the plurality of UI elements on a user interface (111) associated with the image processing system (107); and
update dynamically, the plurality of UI elements, the respective positions of the plurality of UI elements, the label corresponding to each of the plurality of UI elements and the level of each of the plurality of UI elements on receiving one or more inputs from a user.

8. The image processing system (107) as claimed in claim 6, wherein to obtain the label, the instructions cause the processor (109) to:
obtain sub-image of each of the one or more input images by cropping regions of each of the plurality of UI elements; and
extract, text from each sub-image.

9. The image processing system (107) as claimed in claim 6, wherein the plurality of UI elements is at least one of buttons, tabs, tables, and text boxes.

10. The image processing system (107) as claimed in claim 6, wherein to determine the level of each of the plurality of UI elements across each of the one or more UI screens, the Instructions cause the processor (109) to:
sort each of the plurality of UI elements identified in each of the one or more UI screens based on the respective positions;
identify a common label in the one or more UI screens;
associate the plurality of UI elements in the one or more UI screens based on the common label; and
assign a number to each of the plurality of UI elements based on the association, wherein the number indicates the level of each of the plurality of UI elements.

11. A non-transitory computer readable medium including instructions stored thereon that when processed by at least one processor (109) causes an Image processing system (107) to perform operations comprising:
receiving one or more input images related to one or more UI screens of an application from one or more sources (103);
identifying the plurality of UI elements and respective positions of the plurality of UI elements In each of the one or more input images;
obtaining a label corresponding to each of the plurality of UI elements in each of the one or more input images; and
determining a level of each of the plurality of UI elements identified in each of the one or more UI screens to automatically establish the relationship between the plurality of UI elements across the one or more UI screens.
